(19) United States
(12) Patent Application Publication
(10) Pub. No.: US 2006/0280989 A1
(43) Pub. Date: Dec. 14, 2006

(54) Ion-conducting polymers containing pendant ion conducting groups

(75) Inventor: Jian Ping Chen, Sunnyvale, CA (US)

Correspondence Address: Dorsey & Whitney LLP;Richard F. Trecartin, Suite 1000, 555 California Street, San Francisco, CA, 94104-1513, US

(73) Assignee: Polyfuel, Inc.

(21) Appl. No.: 11/446,006

(22) Filed: Jun. 1, 2006

Related U.S. Application Data
(60) Provisional application No. 60/686,755, filed on Jun. 1, 2005.

(51) Int. Cl. H01M 8/10; C08J 5/20

(52) U.S. Cl. 429/33; 521/25

(57) ABSTRACT

The invention provides ion-conductive copolymers containing pendant ion conducting groups that can be used to fabricate proton exchange membranes (PEM's), catalyst coated proton exchange membranes (CCM's) and membrane electrode assemblies (MEA's) that are useful in fuel cells and their application in electronic devices, power sources and vehicles.

### CROSS-REFERENCE TO RELATED APPLICATION

The present application claims priority to U.S. Provisional Application No. 60/686,755, filed Jun. 1, 2005 which is hereby incorporated by reference in its entirety.

### FIELD OF THE INVENTION

This invention relates to ion-conductive polymers comprising pendant ion conducting groups that are useful in forming polymer electrolyte membranes used in fuel cells.

### BACKGROUND OF THE INVENTION

Fuel cells are promising power sources for portable electronic devices, electric vehicles, and other applications due mainly to their non-polluting nature. Of various fuel cell systems, polymer electrolyte membrane based fuel cells such as direct methanol fuel cells (DMFCs) and hydrogen fuel cells, have attracted significant interest because of their high power density and energy conversion efficiency. The “heart” of a polymer electrolyte membrane based fuel cell is the so called “membrane-electrode assembly” (MEA), which comprises a proton exchange membrane (PEM), catalyst disposed on the opposite surfaces of the PEM to form a catalyst coated membrane (CCM) and a pair of electrodes (i.e., an anode and a cathode) disposed to be in electrical contact with the catalyst layer.

Proton-conducting membranes for DMFCs are known, such as Nafion® from the E.I. Dupont De Nemours and Company or analogous products from Dow Chemical. These perfluorinated hydrocarbon sulfonate ionomer products, however, have serious limitations when used in high temperature fuel cell applications. Nafion® loses conductivity when the operation temperature of the fuel cell is over 80° C. Moreover, Nafion® has a very high methanol crossover rate, which impedes its applications in DMFCs.

U.S. Pat. No. 5,773,480, assigned to Ballard Power System, describes a partially fluorinated proton conducting membrane from α, β, β-trifluorostyrene. One disadvantage of this membrane is its high cost of manufacturing due to the complex synthetic processes for monomer α, β, β-trifluorostyrene and the poor sulfonation ability of poly (α, β, β-trifluorostyrene). Another disadvantage of this membrane is that it is very brittle, thus has to be incorporated into a supporting matrix.

U.S. Patent Nos. 6,300,381 and 6,194,474 to Kerrres, et al. describe an acid-base binary polymer blend system for proton conducting membranes, wherein the sulfonated poly(ether sulfone) was made by post-sulfonation of the poly (ether sulfone).

M. Ueda in the Journal of Polymer Science, 31(1993): 853, discloses the use of sulfonated monomers to prepare the sulfonated poly(ether sulfone polymers).

U.S. Patent Application US 2002/0091225A1 to McGrath, et al. used this method to prepare sulfonated polysulfone polymers.

Ion conductive block copolymers are disclosed in PCT/US2003/015351.

Extensive research has been carried out on the development of new proton conducting polymer membranes for direct methanol fuel and hydrogen fuel cell applications. One approach has been the attachment of the sulfonic acid groups directly to main-chains of aromatic polymers, such as poly(ether ether ketone) (PEEK), polysulfone (PSF), and poly(phenylene sulfide). Although their parent polymers are very stable structures and these sulfonated membranes have shown great promise for use in fuel cell, a general problem with these types of sulfonated polymers is that they start to swell strongly and loose their mechanical stability when a certain degree of sulfonation or a certain operation temperature is exceeded. Further, sulfonic acid or other ion conducting groups in the backbone of ion conducting arylene copolymers lowers copolymer stability because these electron withdrawing groups increase the ease of nucleophilic displacement reactions.

### SUMMARY OF THE INVENTION

To overcome these problems, the ion conducting copolymers have a backbone comprising a backbone with pendant ion-conducting groups, that is ion-conducting groups that are not directly covalently attached to the copolymer backbone. This configuration makes it possible to control the nano-phase separation of the copolymer into hydrophilic, water swollen domains and hydrophobic domains. Consequently, it is feasible to obtain more distinctly separated nano-phases where the cohesion of the hydrophobic main-chain polymer phase is retained despite the formation of a highly water-swollen phase.

The pendent ion-conductive copolymers comprise one or more ion-conductive oligomers (sometimes referred to as ion-conducting segments or ion-conducting blocks) distributed in a polymeric backbone where the polymeric backbone contains at least one, two or three, preferably at least two, of the following: (1) one or more ion conductive monomers, (2) one or more non-ionic monomers and (3) one or more non-ionic oligomers, where the at least one ion-conducting oligomer and/or ion-conducting monomer contains one or more pendent ion-conducting groups. The pendent ion-conducting copolymer can also contain ion conducting groups that are directly attached to the copolymer backbone. The ion conducting oligomers, ion-conducting monomers, non-ionic monomers and/or non-ionic oligomers are covalently linked to each other by oxygen and/or sulfur.

The ion-conductive copolymers that can be used to fabricate polymer electrolyte membranes (PEM's), catalyst coated PEM's (CCM's) and membrane electrode assemblies (MEA's) that are useful in fuel cells such as hydrogen and direct methanol ftiel cells. Such fuel cells can be used in electronic devices, both portable and fixed, power supplies including auxiliary power units (APU's) and for locomotive power for vehicles such as automobiles, aircraft and marine vessels and APU's associated therewith.

### DETAILED DESCRIPTION OF THE INVENTION

The ion-conductive copolymers comprise one or more ion-conductive oligomers distributed in a polymeric backbone where the polymeric backbone contains at least one, two or three, preferably at least two, of the following: (1) one or more ion conductive monomers, (2) one or more non-ionic monomers and (3) one or more non-ionic oligomers, where the at least one ion-conducting oligomer and/or ion-conducting monomer contains one or more pendent ion-conducting groups. The pendent ion-conducting copolymer can also contain ion conducting groups that are directly attached to the copolymer backbone, where the at least one ion-conducting oligomer and/or ion-conducting monomer contains one or more pendent ion-conducting groups. Pendent ion-conducting oligomers are sometimes referred to as P-conducting oligomers. Pendent ion conducting monomers are sometimes referred to as P-conducting monomers.

The pendent ion-conducting copolymer (P-conducting polymer) can also contain ion conducting groups that are directly attached to the copolymer backbone. Ion-conducting oligomers and monomers containing ion conductive groups that are not pendent to the copolymer backbone are sometimes referred to as non-P-oligomers and non-P-monomers respectively.

As used herein, an ion conducting group is pendent if it is not directly attached to the backbone of the polymer. For example, the monomer 3,3′-disulfonated-4,4′difluorobenzophenone (fluorinated S-Bis-K) contains two sulfonic acid groups attached to the phenyl groups of benzophenone. When incorporated into a copolymer, the sulfonic acid groups are attached to a traceable portion of the copolymer backbone i.e. around the phenyl group in the direction to where the sulfonic acid groups are located. These sulfonic acid groups are not pendent. However, if the sulfonic acid group is separated from that backbone by one or more atoms, it is a pendant ion-conducting group.

In a preferred embodiment where only pendent ion-conducting groups are used, the P-conducting oligomer comprises first and second comonomers. The first comonomer comprises one or more pendent ion-conducting groups. At least one of the first or second comonomers comprises two leaving groups while the other comonomer comprises two displacement groups. In one embodiment, one of the first or second comonomers is in molar excess as compared to the other so that the oligomer formed by the reaction of the first and second comonomers contains either leaving groups or displacement groups at each end of the ion-conductive oligomer. This precursor ion-conducting oligomer is combined with at least one, two or three, preferably at lest two, of: (1) one or more precursor P-conducting monomers; (2) one or more precursor non-ionic monomers and (3) one or more precursor non-ionic oligomers. The precursor P-conducting monomers, non-ionic monomers and/or non-ionic oligomers each contain two leaving groups or two displacement groups. The choice of leaving group or displacement group for each of the precursor is chosen so that the precursors combine to form an oxygen and/or sulfur linkage.

The term “leaving group” is intended to include those functional moieties that can be displaced by a nucleophilic moiety found, typically, in another monomer. Leaving groups are well recognized in the art and include, for example, halides (chloride, fluoride, iodide, bromide), tosyl, mesyl, etc. In certain embodiments, the monomer has at least two leaving groups. In the preferred polyphenylene embodiments, the leaving groups may be “para” to each other with respect to the aromatic monomer to which they are attached. However, the leaving groups may also be ortho or meta.

The term “displacing group” is intended to include those functional moieties that can act typically as nucleophiles, thereby displacing a leaving group from a suitable monomer. The monomer with the displacing group is attached, generally covalently, to the monomer that contained the leaving group. In a preferred polyarylene example, fluoride groups from aromatic monomers are displaced by phenoxide, alkoxide or sulfide ions associated with an aromatic monomer. In polyphenylene embodiments, the displacement groups are preferably para to each other. However, the displacing groups may be ortho or meta as well.

Table 1 sets forth combinations of exemplary leaving groups and displacement groups. The precursor ion conducting oligomer contains two leaving groups fluorine (F) while the other three components contain fluorine and/or hydroxyl (—OH) displacement groups. Sulfur linkages can be formed by replacing —OH with thiol (—SH). The displacement group F on the ion conducing oligomer can be replaced with a displacement group (eg-OH) in which case the other precursors are modified to substitute leaving groups for displacement groups or to substitute displacement groups for leaving groups.

TABLE 1
Exemplary Leaving Groups (Fluorine) and
Displacement Group (OH) Combinations

| | | | Precursor Ion | |
|---|---|---|---|---|
| Precursor Ion | | Precursor Non | Conducting | Precursor Non |
| Conducting Oligomer | | Ionic Oligomer | Monomer | Ionic Monomer |
| 1) | F | OH | OH | OH |
| 2) | F | F | OH | OH |
| 3) | F | OH | F | OH |
| 4) | F | OH | OH | F |
| 5) | F | F | F | OH |
| 6) | F | F | OH | F |
| 7) | F | OH | F | F |

Preferred combinations of precursors are set forth in lines 5 and 6 of Table 1.

The ion-conductive copolymer may be represented by Formula I:
[[—(Ar₁-T-)ᵢ—Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula I

wherein Ar₁, Ar₂, Ar₃ and Ar₄ are independently the same or different aromatic moieties;

T, U, V and W are linking moieties;

at least one of Ar₁, Ar₂, T or U comprises a pendent ion conducting group;

X are independently —O— or —S—;

i and j are independently integers greater than 1;

a, b, c, and d are mole fractions wherein the sum of a, b ,c and d is 1, a is greater than 0 and at least one, two or three, preferably at least two, of b, c and d are greater than 0; and

m, n, o, and p are integers indicating the number of different oligomers or monomers in the copolymer.

In some embodiments, at least one of Ar₁, Ar₂, T or U, preferably Ar₁ and/or Ar₂, can comprises an ion conducting group that is not pendent to the copolymer backbone.

The preferred values of a, b, c, and d, i and j as well as m, n, o, and p are set forth below.

The ion conducting copolymer may also be represented by Formula II:
[[—(Ar₁-T-)ᵢ—Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula II

wherein Ar₁, Ar₂, Ar₃ and Ar₄ are independently phenyl, substituted phenyl, napthyl, terphenyl, aryl nitrile and substituted aryl nitrile;

T, U, V and W are independently a bond, —C(O)—,

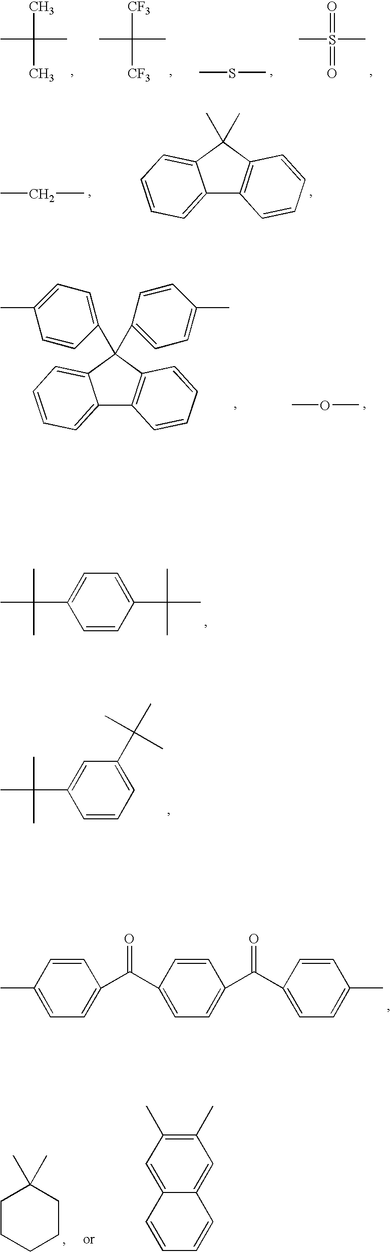

X are independently —O— or —S—;

at least one of Ar₁, Ar₂, T or U comprises a pendent ion-conducting group where T or U are

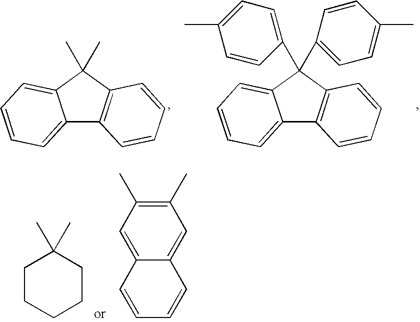

i and j are independently integers greater than 1; and

a, b, c, and d are mole fractions wherein the sum of a, b, c and d is 1, a is greater than 0 and at least one two or three, preferably at least two, of b, c and d are greater than 0; and

m, n, o, and p are integers indicating the number of different oligomers or monomers in the copolymer.

In some embodiments, at least one of Ar₁, Ar₂, T or U, preferably Ar₁ and/or Ar₂, can comprises an ion conducting group that is not pendent to the copolymer backbone.

The ion-conductive copolymer can also be represented by Formula III:
[[—(Ar₁-T-)ᵢ—Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula III

wherein Ar₁, Ar₂, Ar₃ and Ar₄ are independently phenyl, substituted phenyl, napthyl, terphenyl, aryl nitrile and substituted aryl nitrile;

where T, U, V and W are independently a bond O, S, C(O), S(O₂), alkyl, branched alkyl, fluoroalkyl, branched fluoroalkyl, cycloalkyl, aryl, substituted aryl or heterocycle;

X are independently —O— or —S—;

at least one of Ar₁, Ar₂, T or U comprises a pendent ion-conducting group where T or U are branched alkyl, branched fluoroalkyl, cycloalkyl, aryl, substituted aryl or heterocycle;

i and j are independently integers greater than 1;

a, b, c, and d are mole fractions wherein the sum of a, b, c and d is 1, a is greater than 0 and at least one, two or three, preferably at least two, of b, c and d are greater than 0; and

m, n, o, and p are integers indicating the number of different oligomers or monomers in the copolymer.

In some embodiments, at least one of Ar₁, Ar₂, T or U, preferably Ar₁ and/or Ar₂, can comprises an ion conducting group that is not pendent to the copolymer backbone.

In each of the forgoing formulas I, II and III [—(Ar₁-T-)ᵢ—Ar₁—]ₐ^{m} is an ion conducting oligomer; (—Ar₂—U—Ar₂—)_{b}ⁿ is an ion conducting monomer; [(—Ar₃—V—)ⱼ—Ar₃—]_{c}^{o} is a non-ionic oligomer; and (—Ar₄—W—Ar₄—)_{d}^{p} is a non-ionic monomer. Accordingly, these formulas are directed to pendent ion-conducting polymers that include P or non-P ion conducting oligomer(s) in combination at least one of: (1) one or more P or non-P ion conductive monomers, (2) one or more non-ionic monomers and (3) one or more non-ionic oligomers.

In preferred embodiments, i and j are independently from 2 to 12, more preferably from 3 to 8 and most preferably from 4 to 6.

The mole fraction “a” of ion-conducting oligomer in the copolymer is greater than zero and is between 0.1 and 0.9, preferably from 0.3 and 0.9, more preferably from 0.3 to 0.7 and most preferably from 0.3 to 0.5.

The mole fraction “b” of ion conducting monomer in the copolymer is preferably from 0 to 0.5, more preferably from 0.1 to 0.4 and most preferably from 0.1 to 0.3.

The mole fraction of “c” of non-ion conductive oligomer is preferably from 0 to 0.3, more preferably from 0.1 to 0.25 and most preferably from 0.01 to 0.15.

The mole fraction “d” of non-ion conducting monomer in the copolymer is preferably from 0 to 0.7, more preferably from 0.2 to 0.5 and most preferably from 0.2 to 0.4.

When b and d are zero or b is zero, the pendent ion conducting copolymer is a block copolymer containing pendent ion-conducting oligomers and non-ionic oligomers or non-ionic oligomers and monomers.

In some instance, b, c and d are all greater then zero. In other cases, a and c are greater than zero and b and d are zero. In other cases, a is greater than zero, b is greater than zero and at least c or d or c and d are greater than zero. Nitrogen is generally not present in the copolymer backbone.

The indices m, n, o, and p are integers that take into account the use of different monomers and/or oligomers in the same copolymer or among a mixture of copolymers, where m is preferably 1, 2 or 3, n is preferably 1 or 2, o is preferably 1 or 2 and p is preferably 1, 2, 3 or 4.

In some embodiments at least two of Ar₂, Ar₃ and Ar₄ are different from each other. In another embodiment Ar₂, Ar₃ and Ar₄ are each different from the other.

In some embodiments, when there is no hydrophobic oligomer, i.e. when c is zero in Formulas I, II, or III: (1) the precursor ion conductive monomer used to make the ion-conducting polymer is not 2,2′ disulfonated 4,4′ dihydroxy biphenyl; or (2) the ion conductive polymer does not contain the ion-conducting monomer that is formed using this precursor ion conductive monomer.

The following are some of the monomers used to make ion-conductive copolymers.

TABLE 2

| | | | |
|---|---|---|---|
| Acronym | Full name | Molecular weight | Chemical structure |

1) Precursor Difluoro-end monomers

| | | | |
|---|---|---|---|
| Bis K | 4,4′-Difluorobenzophenone | 218.20 | 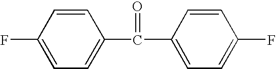 |
| Bis SO₂ | 4,4′-Difluorodiphenylsulfone | 254.25 | 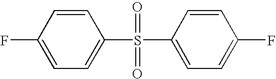 |
| S-Bis K | 3,3′-disulfonated-4,4′-di- fluorobenzophone | 422.28 | 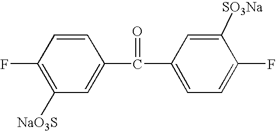 |

2) Precursor Dihydroxy-end monomers

| | | | |
|---|---|---|---|
| Bis AF (AF or 6F) | 2,2-Bis(4-hydroxyphenyl) hexafluoropropane or 4,4′-(hexafluoroisopropylidene) diphenol | 336.24 | 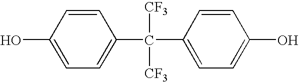 |
| BP | Biphenol | 186.21 | 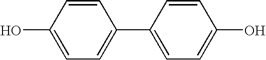 |
| Bis FL | 9,9-Bis(4-hydroxyphenyl)fluorene | 350.41 | 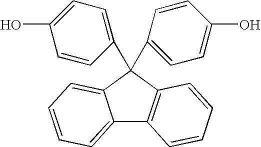 |
| Bis Z | 4,4′-cyclohexylidenebisphenol | 268.36 | 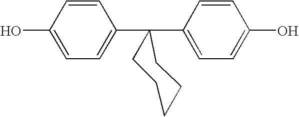 |
| Bis S | 4,4′-thiodiphenol | 218.27 | 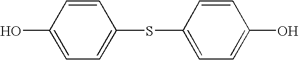 |

3) Precursor Dithiol-end monomer

| | |
|---|---|
| 4,4′-thiol bis benzene thiol | 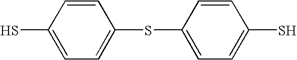 |

These and other monomers can be modified to contain a pendant ion-conducting group.

Examples of linking monomers containing one or more pendent ion conducting groups include but are not limited to: 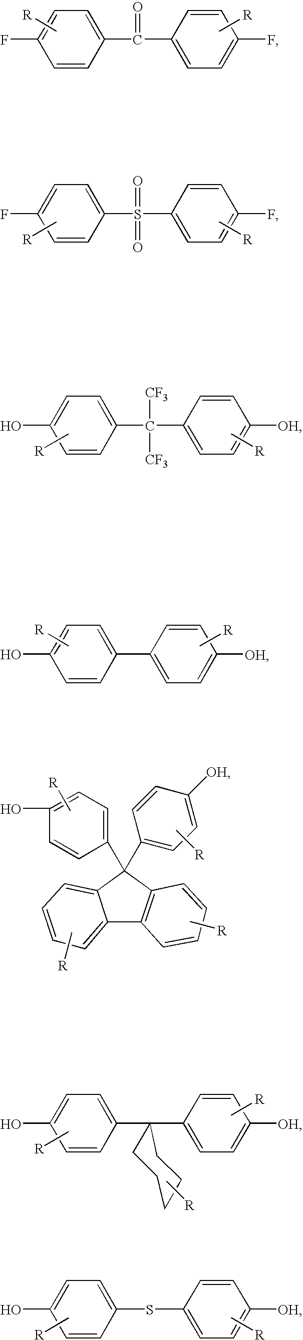 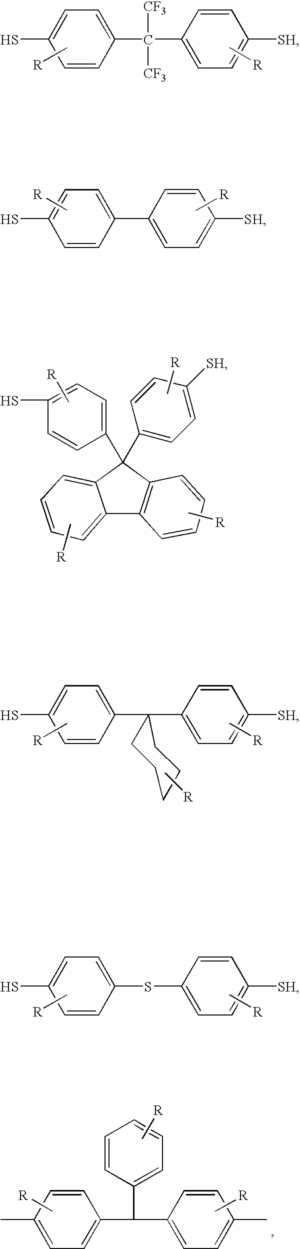 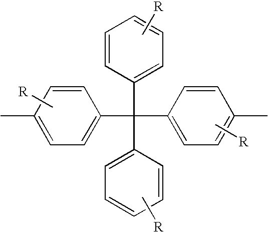
where R is a pendent ion conducting group.

2,3-dihydroxynaphthalene-6-sulfonate sodium is an example of a monomer containing a sulfonic acid group that will be pendant to the ion conductive copolymer backbone when incorporated into the copolymer via the hydroxyl groups at positions 2 and 3.

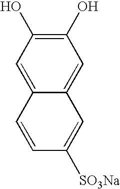

Compositions containing the ion-conducting polymers comprise a population or mixture of copolymers where the ion-conducting oligomer(s) are randomly distributed within the copolymer. In the case of a single ion-conducting oligomer, a population is produced where the ion-conducting oligomer will have tails of varying length at one or both ends of the oligomer that are made of at least one, two or three, preferably at least two, of (1) one or more ion conducting comonomers; (2) one or more non-ionic monomers and (3) one or more non-ionic oligomers. In the case of a multiplicity of ion-conducting oligomers, the population of copolymers will contain ion-conducting oligomers wherein the spacing between ion-conducting oligomers will vary within a single copolymer as well as among the population of copolymers. When multiple ion-conducting oligomers are desired, it is preferred that the copolymer contain on average between 2 and 35 ion-conducting oligomers, more preferably between 5 and 35, still more preferably between 10 and 35, and most preferably between 20 and 35 ion-conducting oligomers.

Ion conducting copolymers and the monomers used to make them and which are not otherwise identified herein can also be used. Such ion conducting copolymers and monomers include those disclosed in U.S. patent application Ser. No. 09/872,770, filed Jun. 1, 2001, Publication No. US 2002-0127454 A1, published Sep. 12, 2002, entitled “Polymer Composition”; U.S. patent application Ser. No. 10/351,257, filed Jan. 23, 2003, Publication No. US 2003-0219640 A1, published Nov. 27, 2003, entitled “Acid Base Proton Conducting Polymer Blend Membrane”; U.S. patent application Ser. No. 10/438,186, filed May 13, 2003, Publication No. US 2004-0039148 A1, published Feb. 26, 2004, entitled “Sulfonated Copolymer”; U.S. patent application Ser. No. 10/438,299, filed May 13, 2003, entitled “Ion-conductive Block Copolymers,” published July 1, 2004, Publication No. 2004-0126666; U.S. application Ser. No. 10/449,299, filed Feb. 20, 2003, Publication No. US 2003-0208038 A1, published Nov. 6, 2003, entitled “Ion-conductive Copolymer”; U.S. patent application Ser. No. 10/438,299, filed May 13, 2003, Publication No. US 2004-0126666; U.S. patent application Ser. No. 10/987,178, filed Nov. 12, 2004, entitled “Ion-conductive Random Copolymer”, Publication No.2005-0181256 published Aug. 18, 2005; U.S. patent application Ser. No. 10/987,951, filed Nov. 12, 2004, Publication No. 2005-0234146, published Oct. 20, 2005, entitled “Ion-conductive Copolymers Containing First and Second Hydrophobic Oligomers;” U.S. patent application Ser. No. 10/988,187, filed Nov. 11, 2004, Publication No. 2005-0282919, published Dec. 22, 2005, entitled “Ion-conductive Copolymers Containing One or More Hydrophobic Oligomers”; and U.S. patent application Ser. No. 11/077,994, filed Mar. 11, 2005, Publication No. 2006-004110, published Feb. 23, 2006, each of which are expressly incorporated herein by reference. Other comonomers include those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A1); graft polystyrene (Macromolecules 35: 1348 (2002)); polyimides (U.S. Pat. No. 6,586,561 and J. Membr. Sci. 160: 127 (1999)) and Japanese Patent Applications Nos. JP2003147076 and JP2003055457, each of which are expressly identified herein by reference.

The mole percent of ion-conducting groups when only one ion-conducting group is present in a comonomer is preferably between 30 and 70%, or more preferably between 40 and 60%, and most preferably between 45 and 55%. When more than one conducting group is contained within the ion-conducting monomer, such percentages are multiplied by the total number of ion-conducting groups per monomer. Thus, in the case of a monomer comprising two sulfonic acid groups, the preferred sulfonation is 60 to 140%, more preferably 80 to 120%, and most preferably 90 to 110%. Alternatively, the amount of ion-conducting group can be measured by the ion exchange capacity (IEC). By way of comparison, Nafion(® typically has a ion exchange capacity of 0.9 meq per gram. In the present invention, it is preferred that the IEC be between 0.9 and 3.0 meq per gram, more preferably between 1.0 and 2.5 meq per gram, and most preferably between 1.6 and 2.2 meq per gram.

Ion conducting copolymers and the monomers used to make them and which are not otherwise identified herein can also be used. Such ion conducting copolymers and monomers include those disclosed in U.S. patent application Ser. No. 09/872,770, filed Jun. 1, 2001, Publication No. US 2002-0127454 A1, published Sep. 12, 2002, entitled “Polymer Composition”; U.S. patent application Ser. No. 10/351,257, filed Jan. 23, 2003, Publication No. US 2003-0219640 A1, published Nov. 27, 2003, entitled “Acid Base Proton Conducting Polymer Blend Membrane”; U.S. patent application Ser. No. 10/438,186, filed May 13, 2003, Publication No. US 2004-0039148 A1, published Feb. 26, 2004, entitled “Sulfonated Copolymer”; U.S. patent application Ser. No. 10/438,299, filed May 13, 2003, entitled “Ion-conductive Block Copolymers,” published Jul. 1, 2004, Publication No. 2004-0126666; U.S. application Ser. No. 10/449,299, filed Feb. 20, 2003, Publication No. US 2003-0208038 A1, published Nov. 6, 2003, entitled “Ion-conductive Copolymer”; U.S. patent application Ser. No. 10/438,299, filed May 13, 2003, Publication No. US 2004-0126666; U.S. patent application Ser. No. 10/987,178, filed Nov. 12, 2004, entitled “Ion-conductive Random Copolymer”, Publication No.2005-0181256 published Aug. 18, 2005; U.S. patent application Ser. No. 10/987,951, filed Nov. 12, 2004, Publication No. 2005-0234146, published Oct. 20, 2005, entitled “Ion-conductive Copolymers Containing First and Second Hydrophobic Oligomers;” U.S. patent application Ser. No. 10/988,187, filed Nov. 11, 2004, Publication No. 2005-0282919, published Dec. 22, 2005, entitled “Ion-conductive Copolymers Containing One or More Hydrophobic Oligomers”; and U.S. patent application Ser. No. 11/077,994, filed Mar. 11, 2005, Publication No. 2006-004110, published Feb. 23, 2006, each of which are expressly incorporated herein by reference. Other comonomers include those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A1); graft polystyrene (Macromolecules 35: 1348 (2002)); polyimides (U.S. Pat. No. 6,586,561 and J. Membr. Sci. 160: 127 (1999)) and Japanese Patent Applications Nos. JP2003147076 and JP2003055457, each of which are expressly identified herein by reference.

Although the copolymers of the invention have been described in connection with the use of arylene polymers, the principle of using ion-conductive oligomers in combination with at least one, two or three, preferably at least two, of: (1) one or more ion conducting comonomers; (2) one or more non-ionic monomers and (3) one or more non-ionic oligomers to form pendent ion-conducting polymers, can be applied to many other systems. For example, the ionic oligomers, non-ionic oligomers as well as the ionic and non-ionic monomers need not be arylene but rather may be aliphatic or perfluorinated aliphatic backbones containing ion-conducting groups. Ion-conducting groups may be attached to the backbone or may be pendant to the backbone, e.g., attached to the polymer backbone via a linker. Alternatively, ion-conducting groups can be formed as part of the standard backbone of the polymer. See, e.g., U.S. 2002/018737781, published Dec. 12, 2002 incorporated herein by reference. Any of these ion-conducting oligomers can be used to practice the present invention.

Polymer membranes may be fabricated by solution casting of the ion-conductive copolymer.

When cast into a membrane for use in a fuel cell, it is preferred that the membrane thickness be between 0.1 to 10 mils, more preferably between 1 and 6 mils, most preferably between 1.5 and 2.5 mils.

As used herein, a membrane is permeable to protons if the proton flux is greater than approximately 0.005 S/cm, more preferably greater than 0.01 S/cm, most preferably greater than 0.02 S/cm.

As used herein, a membrane is substantially impermeable to methanol if the methanol transport across a membrane having a given thickness is less than the transfer of methanol across a Nafion membrane of the same thickness. In preferred embodiments the permeability of methanol is preferably 50% less than that of a Nafion membrane, more preferably 75% less and most preferably greater than 80% less as compared to the Nafion membrane.

After the ion-conducting copolymer has been formed into a membrane, it may be used to produce a catalyst coated membrane (CCM). As used herein, a CCM comprises a PEM when at least one side and preferably both of the opposing sides of the PEM are partially or completely coated with catalyst. The catalyst is preferable a layer made of catalyst and ionomer. Preferred catalysts are Pt and Pt—Ru. Preferred ionomers include Nafion and other ion-conductive polymers. In general, anode and cathode catalysts are applied onto the membrane using well established standard techniques. For direct methanol fuel cells, platinum/ruthenium catalyst is typically used on the anode side while platinum catalyst is applied on the cathode side. For hydrogen/air or hydrogen/oxygen fuel cells platinum or platinum/ruthenium is generally applied on the anode side, and platinum is applied on the cathode side. Catalysts may be optionally supported on carbon. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (1-3 g) is added and the dispersion is directly sprayed onto the membrane. The catalyst may also be applied onto the membrane by decal transfer, as described in the open literature (Electrochimica Acta, 40: 297 (1995)).

The CCM is used to make MEA's. As used herein, an MEA refers to an ion-conducting polymer membrane made from a CCM according to the invention in combination with anode and cathode electrodes positioned to be in electrical contact with the catalyst layer of the CCM.

The electrodes are in electrical contact with the catalyst layer, either directly or indirectly via a gas diffusion or other conductive layer, so that they are capable of completing an electrical circuit which includes the CCM and a load to which the fuel cell current is supplied. More particularly, a first catalyst is electrocatalytically associated with the anode side of the PEM so as to facilitate the oxidation of hydrogen or organic fuel. Such oxidation generally results in the formation of protons, electrons and, in the case of organic fuels, carbon dioxide and water. Since the membrane is substantially impermeable to molecular hydrogen and organic fuels such as methanol, as well as carbon dioxide, such components remain on the anodic side of the membrane. Electrons formed from the electrocatalytic reaction are transmitted from the anode to the load and then to the cathode. Balancing this direct electron current is the transfer of an equivalent number of protons across the membrane to the cathodic compartment. There an electrocatalytic reduction of oxygen in the presence of the transmitted protons occurs to form water. In one embodiment, air is the source of oxygen. In another embodiment, oxygen-enriched air or oxygen is used.

The membrane electrode assembly is generally used to divide a fuel cell into anodic and cathodic compartments. In such fuel cell systems, a fuel such as hydrogen gas or an organic fuel such as methanol is added to the anodic compartment while an oxidant such as oxygen or ambient air is allowed to enter the cathodic compartment. Depending upon the particular use of a fuel cell, a number of cells can be combined to achieve appropriate voltage and power output. Such applications include electrical power sources for residential, industrial, commercial power systems and for use in locomotive power such as in automobiles. Other uses to which the invention finds particular use includes the use of fuel cells in portable electronic devices such as cell phones and other telecommunication devices, video and audio consumer electronics equipment, computer laptops, computer notebooks, personal digital assistants and other computing devices, GPS devices and the like. In addition, the fuel cells may be stacked to increase voltage and current capacity for use in high power applications such as industrial and residential sewer services or used to provide locomotion to vehicles. Such fuel cell structures include those disclosed in U.S. Pat. Nos. 6,416,895, 6,413,664, 6,106,964, 5,840,438, 5,773,160, 5,750,281, 5,547,776, 5,527,363, 5,521,018, 5,514,487, 5,482,680, 5,432,021, 5,382,478, 5,300,370, 5,252,410 and 5,230,966.

Such CCM and MEM's are generally useful in fuel cells such as those disclosed in U.S. Pat. Nos. 5,945,231, 5,773,162, 5,992,008, 5,723,229, 6,057,051, 5,976,725, 5,789,093, 4,612,261, 4,407,905, 4,629,664, 4,562,123, 4,789,917, 4,446,210, 4,390,603, 6,110,613, 6,020,083, 5,480,735, 4,851,377, 4,420,544, 5,759,712, 5,807,412, 5,670,266, 5,916,699, 5,693,434, 5,688,613, 5,688,614, each of which is expressly incorporated herein by reference.

The CCM's and MEA's of the invention may also be used in hydrogen fuel cells that are known in the art. Examples include U.S. Pat. Nos. 6,630,259; 6,617,066; 6,602,920; 6,602,627; 6,568,633; 6,544,679; 6,536,551; 6,506,510; 6,497,974, 6,321,145; 6,195,999; 5,984,235; 5,759,712; 5,509,942; and 5,458,989 each of which are expressly incorporated herein by reference.

The ion-conducting polymer membranes of the invention also find use as separators in batteries. Particularly preferred batteries are lithium ion batteries.

### EXAMPLES

Random Copolymerizations

### Example 1

In a 500 mL three necked round flask, equipped with a mechanical stirrer, a thermometer probe connected with a nitrogen inlet, and a Dean-Stark trap/condenser, 4,4′-difluorobenzophone (BisK, 19.20 g, 0.088 mol), 3,3′-disulfonated-4,4′-difluorobenzophone (SBisK, 9.29 g, 0.022 mol), bis(4-hydroxyphenyl)-1,4-diisopropylbenzene (30.49 g, 0.088 mol), 2,3-dihydroxynaphthalene-6-sulfonate sodium (5.77 g, 0.022 mol), and anhydrous potassium carbonate (19.76 g, 0.143 mol), 198 mL of DMSO and 99 mL of Toluene. The reaction mixture was slowly stirred under a slow nitrogen stream. After heating at ˜85° C. for 45 min and at ˜120° C. for 30 min, the reaction temperature was raised to 140° C. for 3 h, and at 155° C. for 1.5 h, finally to 165° C. for 2 h. After cooling to 70° C. with continuing stirring, the solution was dropped into 2 L of cooled methanol with a vigorous stirring. The precipitates were filtrated and washed with Di-water four times and dried at 80° C. for one day. The sodium form polymer was exchanged to acid form by washing the polymer in hot sulfuric acid solution (1.5 M) twice (1 h each) and in cold di-water twice. The polymer was then dried at 80° C. overnight and at 80° C. under vacuum for additional day. This polymer has an inherent viscosity of 0.73 dl/g in DMAc (0.25 g/dl).

### Example 2

This polymer was synthesized in a similar way as described in example 1, using following compositions: 4,4′-difluorobenzophone (BisK, 20.40 g, 0.0935 mol), 3,3′-disulfonated-4,4′-difluorobenzophone (SBisK, 6.97 g, 0.0165 mol), 1,1-bis(4-hydroxyphenyl)cyclohexane (23.61 g, 0.088 mol), 2,3-dihydroxynaphthalene-6-sulfonate sodium (5.77 g, 0.022 mol), and anhydrous potassium carbonate (19.76 g, 0.143 mol), 198 mL of DMSO and 99 mL of Toluene. This polymer after acid treatment has an inherent viscosity of 0.62 dl/g in DMAc (0.25 g/dl).

Block Copolymerizations

Oligomer 1 with Fluoride Ending Groups:

In a 500 mL three necked round flask, equipped with a mechanical stirrer, a thermometer probe connected with a nitrogen inlet, and a Dean-Stark trap/condenser, 4,4′-difluorobenzophone (BisK, 34.91 g, 0.16 mol), 9,9-bis(4-hydroxyphenyl)fluorene (42.05 g, 0.12 mol), and anhydrous potassium carbonate (25.87 g, 0.187 mol), 220 mL of DMSO and 110 mL of Toluene. The reaction mixture was slowly stirred under a slow nitrogen stream. After heating at ˜85° C. for 1 h and at ˜120° C. for 1 h, the reaction temperature was raised to ˜135° C. for 3 h, and finally to ˜170° C. for 2 h. After cooling to ˜70° C. with continuing stirring, the solution was dropped into 2 L of cooled methanol with a vigorous stirring. The precipitates were filtrated and washed with Di-water four times and dried at 80° C. for one day and at 80° C. under a vacuum oven for 2 days.

Oligomer 2 with Fluoride Ending Groups:

This oligomer was synthesized in a similar way as described in oligomer 1, using following compositions: bis(4-fluorophenyl) sulfone (71.19 g, 0.28 mol), 9,9-bis(4-hydroxyphenyl)fluorene (73.59 g, 0.21 mol), and anhydrous potassium carbonate (37.73 g, 0.364 mol), 504 mL of DMSO and 252 mL of Toluene.

Oligomer 3 with Fluoride Ending Groups:

This oligomer was synthesized in a similar way as described in oligomer 1, using following compositions: 4,4′-difluorobenzophone (BisK, 28.36 g, 0.13 mol), 4,4′-dihydroxytetraphenylmethane (34.36 g, 0.0975 mol), and anhydrous potassium carbonate (17.51 g, 0.169 mol), 234 mL of DMSO and 117 mL of Toluene.

### Example 3

In a 500 mL three necked round flask, equipped with a mechanical stirrer, a thermometer probe connected with a nitrogen inlet, and a Dean-Stark trap/condenser, 4,4′-difluorobenzophone (BisK, 5.50 g), 3,3′-disulfonated-4,4′-difluorobenzophone (SBisK, 11.15 g), Oligomer 1 (19.59 g), bis(4-hydroxyphenyl)-1,4-diisopropylbenzene (16.63 g), 2,3-dihydroxynaphthalene-6-sulfonate sodium (3.15 g), and anhydrous potassium carbonate (9.70 g, 0.091 mol), were added together with a mixture of anhydrous DMSO (214 mL) and freshly distilled toluene (107 mL). The reaction mixture was slowly stirred under a slow nitrogen stream. After heating at 85° C. for 30 min and at 120° C. for 30 min, the reaction temperature was raised to 140° C. for 3.5 h, 155° C. for 1 h and finally to 165° C. for 1 h. After cooling to ˜70° C. with continuing stirring, the viscous solution was dropped into 1L of cooled methanol with a vigorous stirring. The noodle-like precipitates were cut and washed with di-water four times and dried at 80° C. overnight. The sodium form polymer was exchanged to acid form by washing the polymer in hot sulfuric acid solution (1.5 M) twice (1 h each) and in cold di-water twice. The polymer was then dried at 80° C. overnight and at 80° C. under vacuum for 2 days. This polymer has an inherent viscosity of 0.61 dl/g in DMAc (0.25 g/dl).

### Example 4

This polymer was synthesized in a similar way as described in example 3, using following compositions: 4,4′-difluorobenzophone (BisK, 5.23 g), 3,3′-disulfonated-4,4′-difluorobenzophone (SBisK, 11.66 g), Oligomer 2 (21.11 g), bis(4-hydroxyphenyl)- 1,4-diisopropylbenzene (16.63 g), 2,3-dihydroxynaphthalene-6-sulfonate sodium (3.15 g), and anhydrous potassium carbonate (9.70 g), and 221 mL of DMSO and 111 mL of Toluene. This polymer after acid treatment has an inherent viscosity of 0.97 dl/g in DMAc (0.25 g/dl).

### Example 5

This polymer was synthesized in a similar way as described in example 3, using following compositions: 4,4′-difluorobenzophone (BisK, 6.02 g), 3,3′-disulfonated-4,4′-difluorobenzophone (SBisK, 10.13 g), Oligomer 3 (19.66 g), bis(4-hydroxyphenyl)-1,4-diisopropylbenzene (14.55 g), 2,3-dihydroxynaphthalene-6-sulfonate sodium (4.72 g), and anhydrous potassium carbonate (9.16 g), and 210 mL of DMSO and 105 mL of Toluene. This polymer after acid treatment has an inherent viscosity of 0.45 dl/g in DMAc (0.25 g/dl).

### Example 6

This polymer was synthesized in a similar way as described in example 3, using following compositions: 4,4′-difluorobenzophone (BisK, 17.24 g), 3,3′-disulfonated-4,4′-difluorobenzophone (SBisK, 6.33 g), Oligomer 1 (14.00 g), bis(4-hydroxyphenyl)sulfone (25.03 g), and anhydrous potassium carbonate (17.97 g), and 234 mL of DMSO and 117 mL of Toluene. This polymer after further post-sulfonation by 96% H2SO4 in a concentration of 20% w/w at r.t. overnight has an inherent viscosity of 0.44 dl/g in DMAc (0.25 g/dl).

### Example 7

This polymer was synthesized in a similar way as described in example 3, using following compositions: 3,3′-disulfonated-4,4′-difluorobenzophone (SBisK, 18.81 g), Oligomer 3 (24.45 g), 4,4′-biphenol (7.17 g), 2,3-dihydroxynaphthalene-6-sulfonate sodium (4.33 g), and anhydrous potassium carbonate (8.40 g), and 210 mL of DMSO and 105 mL of Toluene. This polymer after acid treatment has an inherent viscosity of 0.58 dl/g in DMAc (0.25 g/dl).

### Example 8

This polymer was synthesized in a similar way as described in example 3, using following compositions: 3,3′-disulfonated-4,4′-difluorobenzophone (SBisK, 19.97 g), Oligomer 2 (19.35 g), 4,4′-(hexafluoroisopropylidene)diphenol (12.94 g), 2,3-dihydroxynaphthalene-6-sulfonate sodium (4.33 g), and anhydrous potassium carbonate (8.40 g), and 210 mL of DMSO and 105 mL of Toluene. This polymer after acid treatment has an inherent viscosity of 1.14 dl/g in DMAc (0.25 g/dl).

### Example 9

This polymer was synthesized in a similar way as described in example 3, using following compositions: 3,3′-disulfonated-4,4′-difluorobenzophone (SBisK, 19.74 g), Oligomer 1 (19.24 g), 4,4′-(hexafluoroisopropylidene)diphenol (12.94 g), 2,3-dihydroxynaphthalene-6-sulfonate sodium (4.33 g), and anhydrous potassium carbonate (8.40 g), and 210 mL of DMSO and 105 mL of Toluene. This polymer after acid treatment has an inherent viscosity of 0.82 dl/g in DMAc (0.25 g/dl).

### Example 10

This polymer was synthesized in a similar way as described in example 3, using following compositions: 3,3′-disulfonated-4,4′-difluorobenzophone (SBisK, 18.81 g), Oligomer 1 (24.38 g), 4,4′-biphenol (7.17 g), 2,3-dihydroxynaphthalene-6-sulfonate sodium (4.33 g), and anhydrous potassium carbonate (8.40 g), and 210 mL of DMSO and 105 mL of Toluene. This polymer after acid treatment has an inherent viscosity of 0.80 dl/g in DMAc (0.25 g/dl).

### Example 11

In a 500 mL three necked round flask, equipped with a mechanical stirrer, a thermometer probe connected with a nitrogen inlet, and a Dean-Stark trap/condenser, 3,3′-disulfonated-4,4′-difluorobenzophone (SBisK, 9.29 g), 2,3-dihydroxynaphthalene-6-sulfonate sodium (4.33 g), and anhydrous potassium carbonate (2.96 g), were added together with a mixture of anhydrous DMSO (150 mL) and freshly distilled toluene (75 mL). The reaction mixture was slowly stirred under a slow nitrogen stream. After heating at 85° C. for 45 min and at 120° C. for 45 min, the reaction temperature was raised to 140° C. for 2 h, 155° C. for 1 h and finally to 165° C. for 1 h. After cooling to ˜70° C. with continuing stirring, 4,4′-difluorobenzophone (BisK, 19.20 g), bis(4-hydroxyphenyl)-1,4-diisopropylbenzene (32.39 g), and anhydrous potassium carbonate (17.00 g), along with 100 mL of DMSO and 50 mL of toluene, were added to the solution. The mixture was continued to stir at 85° C. for 1 h and at 120° C. for 1 h. The reaction temperature was raised to 140° C. for 2 h, 155° C. for 2.5 h and finally to 165° C. for 1.5 h. After cooling to ˜70° C. with continuing stirring, the viscous solution was dropped into 1L of cooled methanol with a vigorous stirring. The noodle-like precipitates were cut and washed with di-water four times and dried at 80° C. overnight. The sodium form polymer was exchanged to acid form by washing the polymer in hot sulfuric acid solution (1.5 M) twice (1 h each) and in cold di-water twice. The polymer was then dried at 80° C. overnight and at 80° C. under vacuum for 2 days.

TABLE 3
Ex-situ data for membranes 7-9

| | | | Water | | Conductivity |
|---|---|---|---|---|---|
| | | | uptake | Swelling | 60 C./boiled |
| Membrane | IEC | I.V. | (%) | (%) | (S/cm) |
| Membrane 7 | 2.01 | 0.58 | 76 | 59 | 0.10/0.10 |
| Membrane 8 | 2.05 | 1.14 | 116 | 88 | 0.12/0.10 |
| Membrane 9 | 2.04 | 0.82 | 94 | 76 | 0.096/0.082 |

What is claimed is:

1. An ion-conducting copolymer comprising an ion-conducting oligomer and at least two of (1) one or more ion conductive monomers, (2) one or more non-ionic monomers and (3) one or more non-ionic oligomers covalently linked to each other, wherein said copolymer comprises aryl groups in the backbone of said copolymer and wherein at least one of said ion-conducting oligomers and ion-conducting monomers comprises a pendent ion-conducting group.

2. An ion conductive copolymer having the formula
[[—(Ar₁-T-)₁—Ar₁—X—]ₐ^{m}/(—Ar₂—U—Ar₂—X—)_{b}^{m}/[—(Ar₃—V—)ⱼ—Ar₃—X—]_{c}^{o}/(—Ar₄—W—Ar₄—X—)_{d}^{p}/]
wherein Ar₁, Ar₂, Ar₃ and Ar₄ are independently the same or different aromatic moieties;
T, U, V and W are linking moieties;
at least one of Ar₁, Ar₂, T or U comprises a pendent ion conducting group;
X are independently —O— or —S—;
i and j are independently integers greater than 1;
a, b, c, and d are mole fractions wherein the sum of a, b, c and d is 1, a is greater than 0 and at least two of b, c and d is greater than 0; and
m, n, o, and p are integers indicating the number of different oligomers or monomers in the copolymer.

3. The ion-conductive copolymer of claim 2 wherein
Ar₁, Ar₂, Ar₃ and Ar₄ are independently phenyl, substituted phenyl, napthyl, terphenyl, aryl nitrile and substituted aryl nitrile; and
T, U, V and W are independently a bond, —C(O)—,

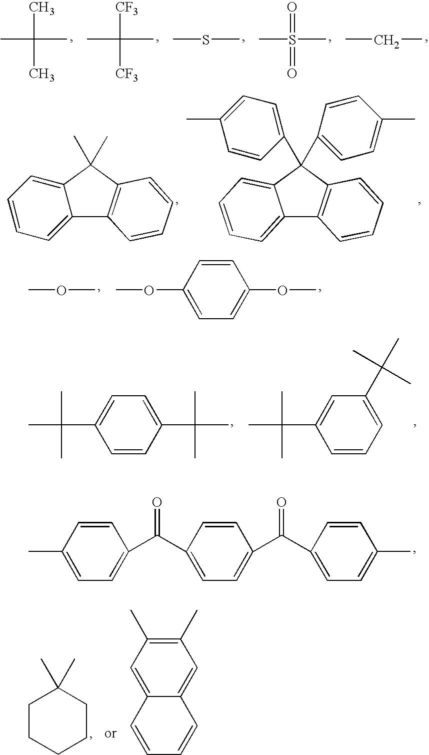

4. The ion-conducting polymer of claim 2 wherein
Ar₁, Ar₂, Ar₃ and Ar₄ are independently phenyl, substituted phenyl, napthyl, and terphenyl, aryl nitrile and substituted aryl nitrile; and
T, U, V and W are independently a bond O, S, C(O), S(O₂), alkyl, branched
alkyl, fluoroalkyl, branched fluoroalkyl, cycloalkyl, aryl, substituted aryl or heterocycle;

5. The ion conducting polymer of claims 1 or 2 wherein at least one of Ar₁, Ar₂, T or U further comprises an ion conducting group that is not pendent to the copolymer backbone.

6. A polymer electrolyte membrane (PEM) comprising the ion-conducting copolymer of claim 1 or 2.

7. A catalyst coated membrane (CCM) comprising the PEM of claim 6 wherein all or part of at least one opposing surface of said PEM comprises a catalyst layer.

8. A membrane electrode assembly (MEA) comprising the CCM of claim 7.

9. A fuel cell comprising the MEA of claim 8.

10. The fuel cell of claim 9 comprising a hydrogen fuel cell.

11. An electronic device comprising the fuel cell of claim 9.

12. A power supply comprising the fuel cell of claim 9.

13. An electric motor comprising the fuel cell of claim 9.

14. A vehicle comprising the electric motor of claim 13.
